(19) United States
(12) Patent Application Publication
(10) Pub. No.: US 2022/0400403 A1
(43) Pub. Date: Dec. 15, 2022

(54) DISTRIBUTED CONGESTION CONTROL FOR SENSOR SHARING

(71) Applicants: Dan VASSILOVSKI, San Diego, CA (US); Shailesh PATIL, San Diego, CA (US); Hong CHENG, San Diego, CA (US); Lan YU, San Diego, CA (US); QUALCOMM Incorporated, San Diego, CA (US)

(72) Inventors: Dan VASSILOVSKI, Del Mar, CA (US); Shailesh PATIL, San Diego, CA (US); Hong CHENG, Basking Ridge, NJ (US); Lan YU, Beijing (CN)

(21) Appl. No.: 17/770,232

(22) PCT Filed: Nov. 8, 2019
(86) PCT No.: PCT/CN2019/116500

§ 371 Date: Apr. 19, 2022

(51) Int. Cl. H04W 28/02; G08G 1/16; H04W 4/40; H04W 4/38; H04W 28/06; G08G 1/0967

(52) U.S. Cl. CPC H04W 28/0289; G08G 1/161; H04W 4/40; H04W 4/38; H04W 28/06; G08G 1/096766

(57) ABSTRACT

In an aspect of the disclosure, methods, a computer-readable media, and apparatus are provided. A method for wireless communication includes detecting a first object using one or more sensors. The method includes receiving one or more messages from one or more second devices indicating detection of one or more second objects. The one or more messages indicating information about the one or more second objects. The method further includes selecting information about the first object to report in a message to one or more third devices based on whether the first object corresponds to at least one object of the one or more second objects in the one or more messages.

### BACKGROUND

### Technical Field

The present disclosure relates generally to communication systems, and more particularly, to methods and systems for sensor sharing.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

In some wireless communications systems, a UE may transmit and receive messages with peers. For example, a UE corresponding to a vehicle may communicate within a vehicle-to-everything (V2X) sidelink network. For example, the UE may communicate with multiple other UEs or other wireless devices concurrently. Vehicles that utilize V2X communication may communicate with each other to increase safety, increase vehicle performance, or enable services such as semi-autonomous or autonomous driving or vehicle platoons.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

In one embodiment, a user equipment (UE) may perform a method for distributed congestion control of sensor-sharing messages. The method may include detecting a first object using one or more sensors. The method may include receiving one or more messages from one or more second devices indicating detection of one or more second objects, the one or more messages indicating information about the one or more second objects. The method may include selecting information about the first object to report in a message to one or more third devices based on whether the first object corresponds to at least one object of the one or more second objects in the one or more messages.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL subframe, DL channels within the DL subframe, an UL subframe, and UL channels within the UL subframe, respectively, for a 5G/NR frame structure.

FIG. 3 is a diagram illustrating an example of a base station and UE in an access network.

FIGS. 4A and 4B are schematic diagrams illustrating object detection and sensor sharing in accordance with certain aspects of the disclosure.

FIG. 5 is a schematic flow chart diagram illustrating a method for distributed congestion control for sensor-sharing messages in accordance with certain aspects of the disclosure.

FIG. 6 is a schematic diagram illustrating object detection and sensor sharing in accordance with certain aspects of the disclosure.

FIG. 7 is a schematic diagram illustrating object detection and sensor sharing in accordance with certain aspects of the disclosure.

FIG. 8 is a schematic swim lane diagram illustrating a method for sensor sharing that supports distributed congestion control in accordance with certain aspects of the disclosure.

FIG. 9 is a diagram illustrating a device that supports distributed congestion control for sensor sharing in accordance with aspects of the present disclosure.

FIG. 10 is a flowchart of a method for distributed congestion control for sensor sharing, in accordance with certain aspects of the disclosure.

### DETAILED DESCRIPTION

Vehicle-to-everything (V2X) application-layer sensor-sharing messages (SSMs) may be used for exchanging information on objects detected by V2X-capable vehicles including on-board units (OBUs), infrastructure components such as road-side units (RSUs), and other devices such as for vulnerable road users (VRUs). The European Telecommunications Standards Institute (ETSI) Intelligent Transport System (ITS) standards group is developing a Collective Perception Message (see TR 103 562) and the Society of Automobile Engineers (SAE) has a work item on Collective Perception Service (see J2945/8). These standards bodies may propose a message structure and a set of information elements for describing the static and dynamic characteristics of detected objects. Detected objects may include vehicles, road features, VRUs, or arbitrary objects. Providing an accurate description of detected objects, along with regular updates to indicate changes in detected object characteristics may be an enabler for automated driving or other driving or safety services.

In some situations, large numbers of detected objects may cause an increase in a transmitted message size. High vehicle density may result in transmissions from multiple vehicles describing the same object. A large number of large messages may use more of the allocated V2X spectrum and may result in congestion and potential message loss. For most efficient use of the available spectrum, it may be desirable to reduce the overall message size and/or reduce a number of messages by omitting redundant or static information. It may also be desirable to use a distributed algorithm to allow a V2X entity to determine how to increase or decrease its message transmission rate or message size based on received SSMs and/or with little coordination between entities or with no centralized control.

Congestion control algorithms based on channel conditions or interference may help reduce congestion. For example, a distributed congestion control (DCC) algorithm defined in the SAE J3161 is based on vehicle determination of congestion conditions through metrics such as Channel Busy Ratio (CBR), vehicle density, and Packet Error Rate (PER). However, such algorithms may be independent of the contents of the underlying application-layer messages. For sensor-sharing messages, metrics such as CBR, vehicle density, and PER, without consideration of message contents, may result in multiple devices transmitting information about the same object. Limiting the number of transmissions may result in suppression of sharing of information about objects that may be useful to other devices.

The present disclosure discusses various methods, systems and devices which may reduce congestion for SSMs by considering contents of SSMs. SSMs may include messages sent by a device indicating information gathered by sensors or indicating information about objects detected by sensors of the device. In one aspect, a device, such as a UE, vehicle, RSU, or VRU compares received detections of an object with its own detection of the object. In a further aspect, the device may determine whether its information will improve knowledge about the object for other V2X entities. The determination of whether the device's detection will improve object knowledge is based on various factors, such as the type of an object, if the object is static or dynamic, object motion state, an accuracy of a classification for the object, an accuracy of a classification reported by another device, the location of the device with respect to other vehicles and/or the detected object, a viewpoint of the device with respect to the object, and/or a viewpoint of other objects that have reported detection of the object. In some cases, a coverage area of the device with respect to coverage areas of other devices that have reported detection of the object may also be a factor. For example, in a managed V2X or cellular-V2X (C-V2X) group, the desired coverage area for the group may be included as a factor. In at least one aspect, the determination of whether the device's detection will improve object knowledge for other devices may occur at an application layer in a V2X capable device such as an OBU, an RSU, or a VRU.

According to one example embodiment, a first device detects a first object using one or more sensors. The first device receives, before or after detecting the first object, one or more messages from one or more second devices indicating detection of one or more second objects. The one or more messages indicate information about the one or more second objects. The first device selects information about the first object to report in a message to one or more third devices based on whether the first object corresponds to at least one object of the one or more second objects in the one or more messages. For example, the first device may include or omit some or all information about the first object in an SSM to be transmitted by the first device based on whether information about the first device has already been shared in the one or more messages from the one or more second devices.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

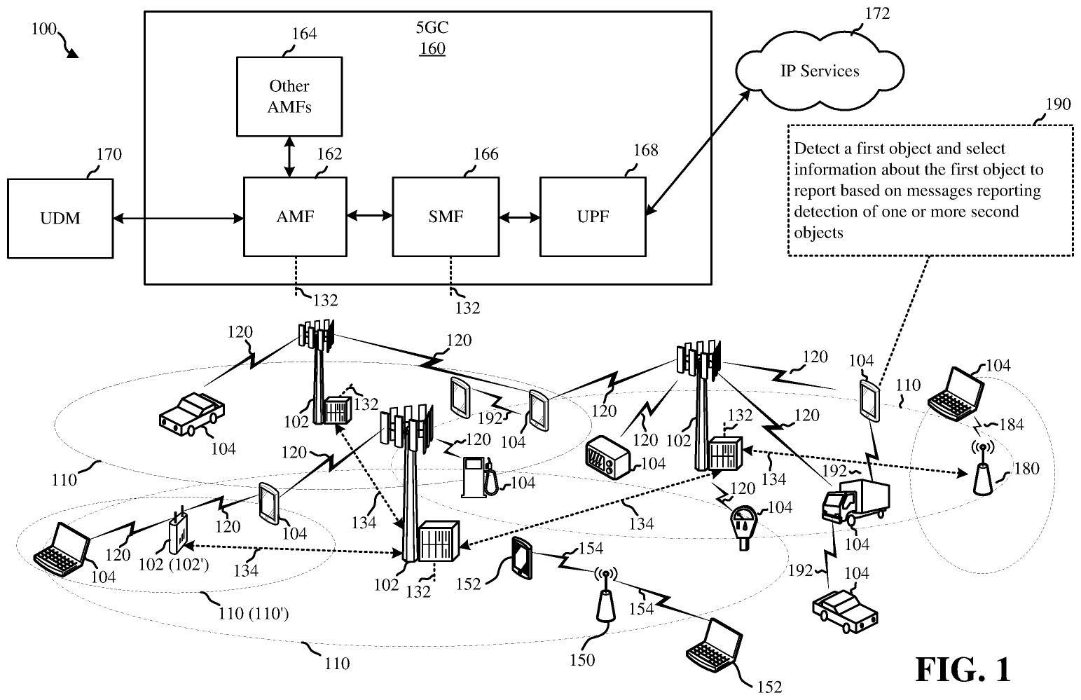

FIG. 1 is a diagram illustrating an example of a wireless communications system and an access network 100. The wireless communications system (also referred to as a wireless wide area network (WWAN)) includes base stations 102, UEs 104, and a 5G Core (5GC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN), Next Generation RAN (NG-RAN)) interface with the 5GC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the 5GC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102 may have a coverage area 110 that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102 may operate in a licensed and/or an unlicensed frequency spectrum. When operating in an unlicensed frequency spectrum, the small cell 102 may employ NR and use the same 5 GHz unlicensed frequency spectrum as used by the Wi-Fi AP 150. The small cell 102, employing NR in an unlicensed frequency spectrum, may boost coverage to and/or increase capacity of the access network.

The gNodeB (gNB) 180 may operate in mmW and/or near mmW frequencies in communication with the UE 104. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW RF band has extremely high path loss and a short range. The mmW base station 180 may utilize beamforming 184 with the UE 104 to compensate for the extremely high path loss and short range.

The 5GC 160 may include an Access and Mobility Management Function (AMF) 162, other AMFs 164, a Session Management Function (SMF) 166, and a User Plane Function (UDP) 168. The AMF 162 may be in communication with a Unified Data Management (UDM) 170. The AMF 162 is the control node that processes the signaling between the UEs 104 and the 5GC 160. Generally, the AMF 162 provides QoS flow and session management. All user Internet protocol (IP) packets are transferred through the UPF 168. The UPF 168 provides UE IP address allocation as well as other functions. The UPF 168 is connected to the IP Services 172. The IP Services 172 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the 5GC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a display, a vehicle UE (VUE) or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, a UE 104 may detect objects in an environment of the UE 104 (such as a driving environment) and report the detection or other information about the object to nearby vehicles or other UEs 104. In one embodiment, the UE 104 may perform operations for congestion control by determining whether a report by the UE 104 of the detection or other information about the object would be redundant to other reporting messages. For example, the UE 104 may detect a first object using one or more sensors. The UE 104 may receive one or more messages from one or more second devices indicating detection of one or more second objects. For example, the UE 104 may receive the one or more messages from another UE 104 or other device over a D2D communication link 192. The one or more messages indicating information about the one or more second objects. The UE 104 may further select information about the first object to report in a message to one or more third devices based on whether the first object corresponds to at least one object of the one or more second objects in the one or more messages. Further aspects or variations are discussed in relation to the remaining figures.

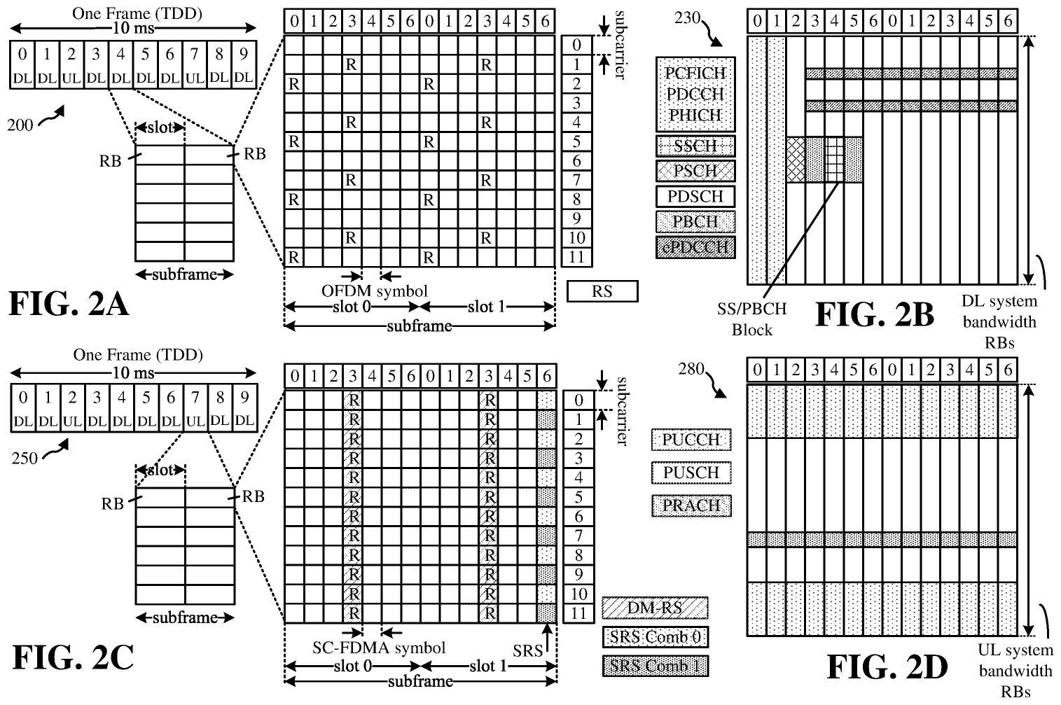

FIG. 2A is a diagram 200 illustrating an example of a DL subframe within a 5G/NR frame structure. FIG. 2B is a diagram 230 illustrating an example of channels within a DL subframe. FIG. 2C is a diagram 250 illustrating an example of an UL subframe within a 5G/NR frame structure. FIG. 2D is a diagram 280 illustrating an example of channels within an UL subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 a DL subframe and subframe 7 an UL subframe. While subframe 4 is illustrated as providing just DL and subframe 7 is illustrated as providing just UL, any particular subframe may be split into different subsets that provide both UL and DL. Note that the description infra applies also to a 5G/NR frame structure that is FDD.

Other wireless communication technologies may have a different frame structure and/or different channels. A frame (10 ms) may be divided into 10 equally sized subframes (1 ms). Each subframe may include one or more time slots. Each slot may include 7 or 14 symbols, depending on the slot configuration. For slot configuration 0, each slot may include 14 symbols, and for slot configuration 1, each slot may include 7 symbols. The number of slots within a subframe is based on the slot configuration and the numerology. For slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. The subcarrier spacing and symbol length/duration are a function of the numerology. The subcarrier spacing may be equal to 2^{μ}* 15 kKz, where μ is the numerology 0-5. The symbol length/duration is inversely related to the subcarrier spacing. FIGS. 2A, 2C provide an example of slot configuration 1 with 7 symbols per slot and numerology 0 with 2 slots per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE (indicated as R). The RS may include demodulation RS (DM-RS) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS)/PBCH block. The MIB provides a number of RB s in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. In one aspect, in CoMP, the SRS may be used by a base station for channel quality estimates which may be used for cluster management and scheduling (e.g., identifying TRPs that may cooperate to transmit to a UE).

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data and may additionally be used to carry a buffer status report (BSR), a power headroom report (PHR), and/or UCI.

Although some of the above discussion of frame structure may relate to communications between a UE and a base station, similar principles or frame structures, with variations, may be applied to communication between peer UEs.

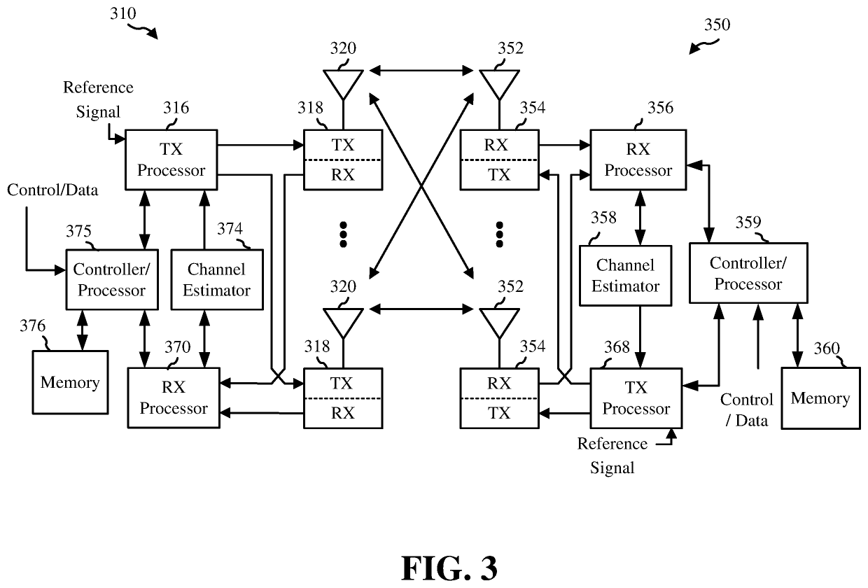

FIG. 3 is a block diagram of a base station 310 in communication with a UE 350 in an access network. In the DL, IP packets from the 5GC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TB s, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the 5GC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the 5GC 160. The controller/processor 375 is also responsible for error detection using an ACK and/or NACK protocol to support HARQ operations.

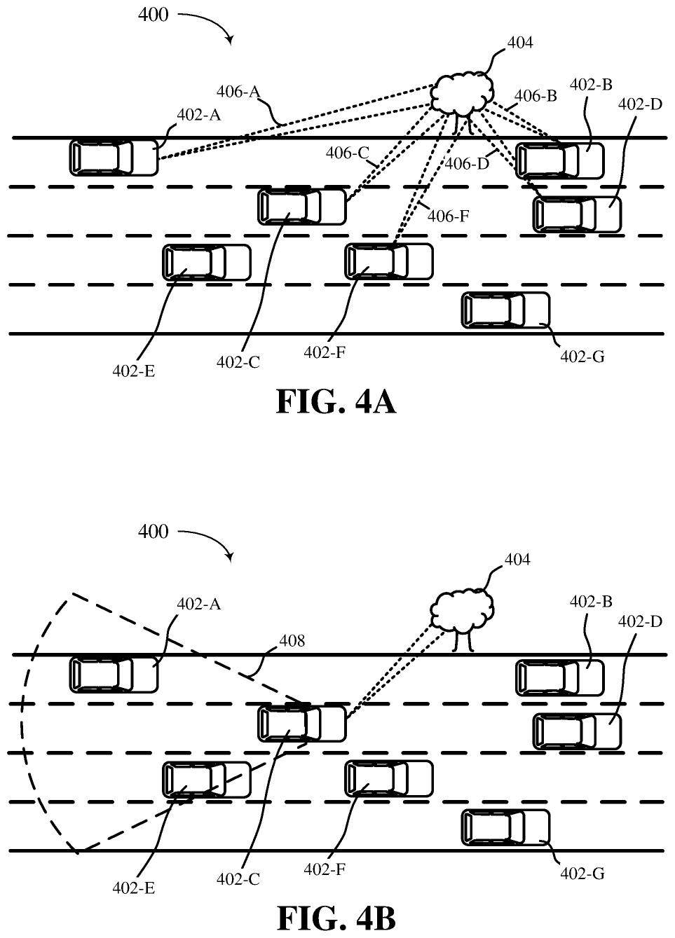

FIGS. 4A and 4B are plan view diagrams of a roadway 400 illustrating object detection and sensor sharing. FIG. 4A illustrates a plurality of vehicles 402-A, 402-B, 402-C, 402-D, 402-E, 402-F, and 402-G on a roadway. Each of the vehicles 402-A, 402-B, 402-C, 402-D, 402-E, 402-F, and 402-G may include an OBU or other device or UE that is capable of transmitting and receiving device-to-device or sidelink V2X messages. Each of the vehicles 402-A, 402-B, 402-C, 402-D, 402-E, 402-F, and 402-G may also be equipped with one or more sensors for sensing a driving environment.

Near the roadway is an object 404 which may be detected by the sensors or other systems of the vehicles 402-A, 402-B, 402-C, 402-D, 402-E, 402-F, and 402-G. As illustrated, vehicle 402-A may detect the object 404 with viewpoint 406-A, vehicle 402-B may detect the object 404 with viewpoint 406-B, vehicle 402-C may detect the object 404 with viewpoint 406-C, vehicle 402-D may detect the object 404 with viewpoint 406-D, and vehicle 402-F may detect the object 404 with viewpoint 406-F. Vehicles 402-E and 402-G, for reasons such as blockage, sensor failure, range limitations, or the like, do not detect the object 404.

According to one aspect, vehicles 402-A, 402-B, 402-C, 402-D, and 402-F may transmit SSMs reporting detection, classification, or other information about the object 404. This may result in information about the object 404 being transmitted in five different messages. Vehicle 402-C and vehicle 402-F may have very similar distance and viewpoints, thus, the quality and information in their detections may be very similar. Vehicle 402-B is close to the object 404 and has a clear view of the object 404, but may have used radar or other sensor that provides less reliable classification than another type of sensor, such as a camera. The viewpoint 406-D of vehicle 402-D is partially occluded by 402-B. Thus, the quality of the detection, information, or classification of vehicle 402-D is likely degraded. Vehicle 402-A is much further away than vehicles 402-B, 402-C, 402-D, and F. The quality of its detection also likely degraded.

In the scenario illustrated in FIG. 4A, five messages may be transmitted by the respective vehicles 402-A, 402-B, 402-C, 402-D, and 402-F. These messages may provide information for each other and for vehicles 402-E and 402-G to utilize, as appropriate, when driving in the region near the object 404. However, there may be a large amount of redundant information in these messages, which may result in wasting wireless resources and increasing receiving and processing workload at the respective vehicles 402-A, 402-B, 402-C, 402-D, 402-E, 402-F, and 402-G. Congestion or excessive workload to share or process information about the object 404 may take resources away from other important tasks, such as the processing or reporting information about a different object or transmitting other messaging between the vehicles.

FIG. 4B shows the vehicles 402-A, 402-B, 402-C, 402-D, 402-E, 402-F, and 402-G of FIG. 4A, in which vehicles 402-A, 402-B, 402-C, 402-D, and 402-F have again detected the object 404. However, at least some of the vehicles 402-A, 402-B, 402-C, 402-D, and 402-F refrain from transmitting information about the object 404, which may help reduce congestion.

In a first example scenario, with reference to FIG. 4B, vehicle 402-C first reports information about the object 404. The report may include a sensor-sharing message or other message reporting information about the object and/or the vehicle 402-C. The other vehicles 402-A, 402-B, 402-D, 402-E, 402-F, and 402-G may refrain from reporting information about the object 404 even if they detect the object 404. For example, vehicles 402-A and 402-D may refrain from reporting due to a low quality of detection/classification. Vehicle 402-F may refrain from reporting because the information is largely redundant with the information reported by vehicle 402-C. The vehicle 402-B may or may not transmit based on a quality of information and/or based on a relative coverage area. For example, vehicle 402-B may refrain from transmitting because the information it provides is of lower quality than vehicle 402-C and/or lower quality than a classification threshold. As another example, vehicle 402-B may report its detection or classification of the object 404 because it has a different coverage area or because it has information from a different viewpoint of the object 404 than vehicle 402-C. If vehicle 402-B and vehicle 402-C are greater than a threshold distance from each other they may cover different regions and thereby notify at least some different vehicles or other devices of the presence of object 404. According to this first example scenario, in comparison to the scenario discussed in relation to FIG. 4A, a reduced number of messages or a reduced message size is sent, thereby reducing usage of wireless resources. The reduced usage of wireless resources may reduce congestion and allow reporting for an increased number of objects, improving sensor sharing capabilities.

In a second example scenario, vehicle 402-B may be the first to transmit a report about object 404. Vehicle 402-C may determine that it's information is redundant with respect to the report of vehicle 402-B, but may also determine that it can provide coverage in a region different than vehicle 402-B. Based on a known location of vehicle 402-B, such as a location received in a SSM or basic safety message (BSM), the vehicle 402-C may send information about the object 404 in a directional transmission 408 to a region not covered by vehicle 402-B. A BSM may include a message that is transmitted periodically by a device, such as a vehicle or other mobile computing device, that provides information about the device's location, speed, device type, or the like. This information in a basic safety message may allow for other devices nearby to detect the device and avoid impact with or otherwise maintain awareness of the device. In one embodiment, the vehicle 402-C may determine a directional beam to use to provide coverage in a region not covered by vehicle 402-B, such as a region where vehicles 402-A and 402-E are located.

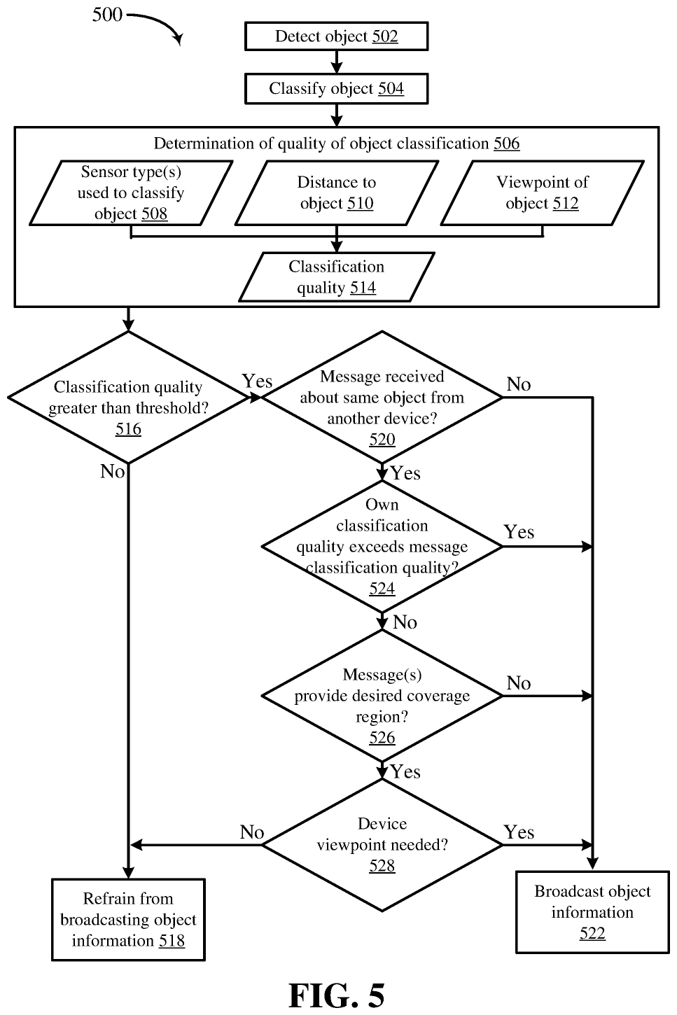

FIG. 5 is a schematic flow chart diagram illustrating a method 500 for distributed congestion control for sensor-sharing messages. The method 500 may be performed by a UE 104 such as one of the UEs 104/350 or other wireless device discussed herein. The UE 104 may be a vehicle, an OBU of a vehicle, a device of a VRU, or other wireless communication device. In one embodiment, the method 500 may be performed by each UE 104 with respect to each object that it detects. Thus, each UE 104 may decide based on object detection and message reception, whether to report information about the detected object. If the information the UE 104 has about the detected object does not add to the information about the object that has already been transmitted or shared by another device, the UE 104 may reduce congestion by refraining from transmitting information about the detected object or only transmitting information which has not yet been transmitted by another device.

The UE 104 detects 502 an object. The UE 104 detects the object in an environment of the UE 104, such as on or near a roadway of a vehicle that includes the UE 104, using one or more sensors. The UE 104 may include the sensors or may be in communication with the one or more sensors. For example, the one or more sensors may be mounted on a vehicle and the UE 104 may be integrated or mounted on or in the vehicle. The UE 104 may receive sensor information from the one or more sensors or from a system that includes the one or more sensors.

The UE 104 classifies 504 the detected object. The UE 104 may classify 504 the object by assigning the classification or receiving the classification from a system in communication with the UE 104 and/or that is traveling with the UE 104. The classification may include a classification of the object as one or more of a static or stationary object (such as a curb, building, railing, tree or other plant, or the like), a dynamic or moving object (such as a vehicle VRU, debris, animal, stroller, bicycle, or the like), a hazardous object, a non-hazardous object, or other classification. The classification may be specific as to a type of motor vehicle such as a motorbike, compact car, truck, bus, tractor trailer, or the like. The classification may also be specific as to a type of non-motor vehicle such as a pedestrian, child, adult, wheelchair, bicycle, stroller, animal, or the like. The classification may also be specific as to a type of stationary object such as a bush, tree, railing, bollard, or the like. The UE 104 or sensor system may classify the object based on an image, radar signature, LIDAR signature, a dimension of the object, or other detected attribute of the object.

The UE 104 determines 506 a classification quality for the object classification at 504. The UE 104 may determine 506 the classification quality by assigning the classification quality or receiving the classification quality from a system associated with the sensors, such as an on-board sensing system of a vehicle. The UE 104 or sensing system may assign the classification quality based on the sensor types used to classify the object 508. For example, some sensor types may be able to provide a more reliable classification. It may be that a visual light camera, when operating in daylight, may provide a most reliable classification while a radar or LIDAR system may have a lower reliability. Thus, a classification determined based on images from a visual light camera may have a higher classification quality than a classification determined based on a RADAR signature. Furthermore, a classification determined based on data from a plurality of sensor types (such as based on aggregate or fused sensor data) may have a higher classification quality than a classification determined based on data from only one of those sensor types. Thus, sensor accuracy or aggregate sensor accuracy may affect the classification quality.

The UE 104 or sensing system may assign the classification quality based on a distance to the object 510. For example, objects that are nearer to the UE 104 or a sensor corresponding to the UE 104, may have more sensor data or more accurate sensor data. Thus, a classification based on sensor data obtained near to the object may have a higher classification quality while sensor data obtained further away from the object may have a lower classification quality. Furthermore, certain types of sensors may be considered to have different levels of reliability at different ranges of distance. In one embodiment, the classification quality may be determined based on which range the distance to the object falls in.

The UE 104 or sensing system may assign the classification quality based on a viewpoint of the object 512. The viewpoint may include information such as a degree of obstruction (10 percent obstructed, or other value), and a viewing angle. The degree of obstruction may indicate whether another object partially obstructs view of the detected object. The viewing angle may indicate an azimuth viewing angle of the object by the one or more sensors, such as an angle relative to north or to a direction of travel of the UE 104. According to one embodiment, a viewing angle matching a direction of travel may result in a higher classification score than other viewing angles. According to another embodiment, a viewing angle normal (i.e., perpendicular) to a direction of travel may have a higher classification score than other viewing angles. The viewing angle may indicate an elevation viewing angle of the object by the one or more sensors, such as an angle relative to horizontal. A positive viewing angle may indicate that the sensor is viewing the object from above while a negative viewing angle may indicate that the sensor is viewing the object from below. According to one embodiment, a positive viewing angle may result in a higher classification score than negative or horizontal viewing angles. According to one embodiment, the viewing angle (viewpoint) may provide an improved classification for detected objects that are dynamic in nature. Objects that are dynamic in nature may include pedestrians, cyclists, or other objects in motion. For those objects sensor data collected from different or multiple viewpoints may result in improved classification quality.

The UE 104 or sensor system may determine the classification quality based on a combination of the sensor types 508, distance 510, viewpoint 512, and/or other information. The resulting classification quality 514 may be assigned to the object and may be used by the UE 104 in determining whether to report information about the detected object. The classification quality may be a numerical value or other value that indicates a relative quality of the classification. For example, the classification quality may be a value from 1 to 100, with a higher number indicating a higher classification quality. As another example, the classification quality may be one of high, medium, or low.

Based on the classification quality 514, a UE 104 may determine whether the information it has detected about the object would be of use to other UEs or wireless communication devices. The processes at 516, 520, 524, 526, and 528 may be part of a process for determining whether the classification quality 514 would be additive to already information about the object transmitted by other devices or would be useful in light of already information about the object transmitted by other devices. After determining the classification quality at 506, the UE 104 determines whether the classification quality exceeds a threshold at 516. The threshold may limit reporting of object classifications or other details about an object if the object detection has a low likelihood of accuracy. If the classification quality does not exceed the threshold, “No” at 516, the UE 104 refrains 518 from broadcasting information about the object.

If the classification quality does exceed the threshold, “Yes” at 516, the UE 104 determines whether a message from another device has been received about the same object at 520. For example, the UE 104 may compare one or more details about the detected object with the reported object to determine whether they are the same object. Some of the details that may be compared may include a classification of the object, a location of the object, a dimension of the object, or any other information about the object that are reported in the message form the other device. If the details about the detected object match or are similar to the details about an object reported in the message, then the UE 104 may determine that they are the same object. If the UE 104 determines that a message about the same object has not been received, “No” at 520, the UE 104 broadcasts object information for the object at 522. The determination at 520 may also account for an age of the message compared to the age of the detection. In one embodiment, if the age of the message is not within a threshold time of the age of the detection, then the UE 104 may determine that no message about the same object has been received (“No” at 520).

If the UE 104 determines that a message about the same object has been received, “Yes” at 520, the UE 104 determines at 524 whether the classification quality determined at 506 exceeds a classification quality for the same object in the message. For example, if the classification quality of the detected object at the UE 104 is high and the classification quality for the same object in the message is low, the UE 104 may determine that the classification quality determined at 506 exceeds a classification quality for the same object in the message (“Yes” at 524). If the UE 104 determines that the classification quality determined at 506 exceeds the classification quality in the message, “Yes” at 524, the UE 104 broadcasts object information for the object at 522.

If the UE 104 determines that the classification quality determined at 506 does not exceed the classification quality in the message “No” at 524, the UE 104 determines whether the received message provides coverage for a desired coverage area at 526. The desired coverage area may include at least a portion of an area covered by the UE 104. For example, the UE 104 may have a different coverage area that does not overlap with a coverage area of the message (i.e., a coverage area of the vehicle that transmitted the message). According to one embodiment, the UE 104 may determine that a desired coverage area is not covered by the message of the transmitting vehicle is greater than a threshold distance away from the UE 104 or if a received power of the message is below a threshold. According to one embodiment, the UE 104, based on a knowledge of a location of the device that transmitted the message, may determine whether a portion of its coverage area that does not overlap with the transmitting devices coverage area includes a roadway, walkway, parking lot, or other area where a device may benefit from knowledge of information about the detected object. As a further or alternative embodiment, a desired coverage region may be defined based on a group targeted for receiving the information. For example, if the UE 104 is part of a platoon or other group, the desired coverage region may include a region that includes the members of the platoon or other group. If the UE 104 determines that the received message does not provide coverage for a desired coverage area, “No” at 526, the UE 104 broadcasts object information for the object at 522. In one embodiment, the UE 104 may determine a directional transmission, such as by selecting a beam for use when broadcasting the object information at 522.

If the UE 104 determines that the received message does provide coverage for a desired coverage area, “Yes” at 526, the UE 104 determines whether the viewpoint of the UE 104 is needed at 528. For example, if the message includes information about the object based on a viewpoint from a first angle (azimuth or elevation angle) it may still be desirable for information from a different angle to be broadcast. If the viewpoint of the UE 104 is different enough from the viewpoint of the message, the UE 104 may determine that the viewpoint of the UE 104 is needed, “Yes” at 428. The UE 104 may determine its own viewpoint based on a location of the UE 104, a location of the sensor used to detect the object, or the location of a parent vehicle of the UE 104 and a location of the detected object. The UE 104 may determine the viewpoint of the message based on a location of the object and a location of the device that transmitted the message or detected the object. The location of the transmitting device may be determined based on the message itself or based on a different message, such as a basic safety message, from the transmitting device. Threshold differences for angles in azimuth or elevation that indicate the need for a new viewpoint may be different for dynamic or static objects. For example, a dynamic (moving) object may benefit from a greater number of vantage points to more accurately classify it or determine its location or other attribute. Similarly, if the object is a static object, the UE 104 may determine that no additional viewpoint is needed as a static object may only require one report while multiple reports may be needed if an object is a dynamic object. If the UE 104 determines that the viewpoint of the UE 104 is not needed, “No” at 528, the UE 104 refrains 518 from broadcasting information about the object. If the UE 104 determines that the viewpoint of the UE 104 is needed, “Yes” at 528, the UE 104 broadcasts information about the object at 522.

Refraining from broadcasting object information at 518 may include refraining from transmitting any message about detected objects or may include transmitting a message about detected objects without including information about the specific object detected at 502. For example, the UE 104 may transmit a sensor-sharing message periodically that indicate all objects that were both (1) detected and (2) for which the method 500 determined to broadcast the object information at 522. Broadcasting object information at 522 may include broadcasting a subset of the information about the detected object, such as information that is non-redundant with information in already received message, or may include broadcasting a full set of information about the object detected at 502. In some cases, even if the object has been reported in another message, nearby devices may benefit from receiving more than one report so that they can aggregate or fuse information in multiple messages to more accurately classify the object or determine the location of the object.

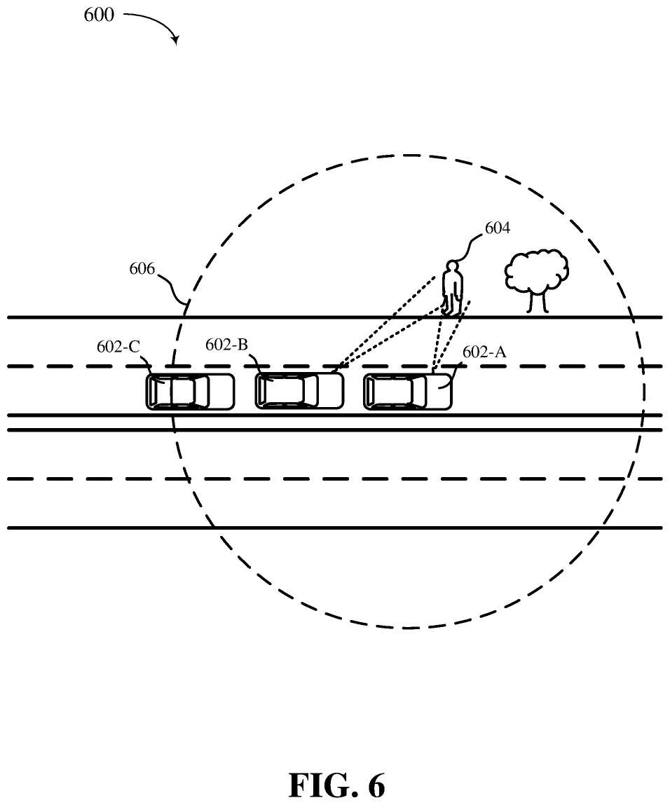

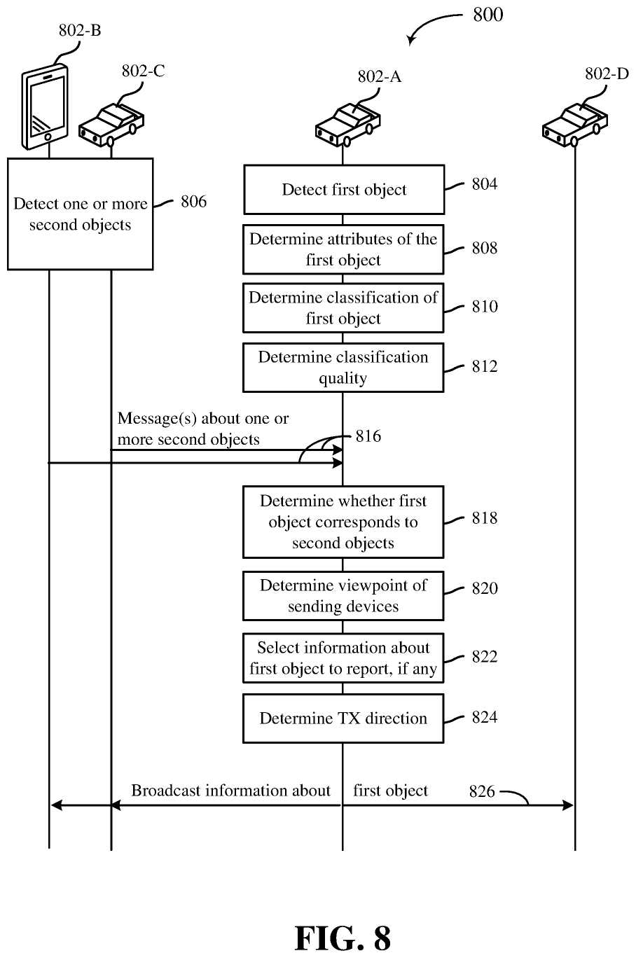

FIG. 6 is a schematic diagram illustrating a roadway 600 with a platoon of vehicles 602-A, 602-B, and 602-C. Each of the vehicles 602-A, 602-B, and 602-C may be an example of or include a UE 104/350 or other wireless communication device discussed herein. Each of the vehicles 602-A, 602-B, and 602-C may be part of a platoon which coordinates maneuvers and travels together down the roadway 600. Each of the vehicles 602-A, 602-B, and 602-C may perform a distributed congestion algorithm, such as by performing the method discussed in relation to FIG. 5 or 8 on each detected object or one or more detected objects.

In an example scenario, vehicles 602-A and 602B detect a pedestrian 604. Vehicle 602-A detects the pedestrian first, determines that the pedestrian hasn't been reported (e.g., in a received message) in a sensor-sharing message or other message, and transmits a message indicating the detection, classification, location, direction of travel, or other attributes of the pedestrian 604. For example, the vehicle 602-A may perform the method 500 of FIG. 5 and determine to broadcast object information at 522. Vehicle 602-B detects the pedestrian next and receives the message from vehicle 602-A. Based on performing the method 500 of FIG. 5 the vehicle 602-B may determine to refrain from broadcasting object information at 518. For example, vehicle 602-B may not broadcast the message due to factors such as the vehicle 602-A having obtained a higher classification quality (see 524 of method 500) and the vehicle 602-A having a coverage area 606 that covers all platoon members (see 526 of method 500). Thus, by refraining from transmission of reporting its detection of the pedestrian, vehicle 602-B may help reduce congestion on wireless communication resources. If additional platoon members were outside the coverage region and the vehicle 602-B was able to reach them, the vehicle 602-B may have transmitted a report of the pedestrian 604 (see 526 of method 500). Similarly, other changes in conditions or factors may lead to the vehicle 602-B transmitting a report in addition to vehicle 602-A.

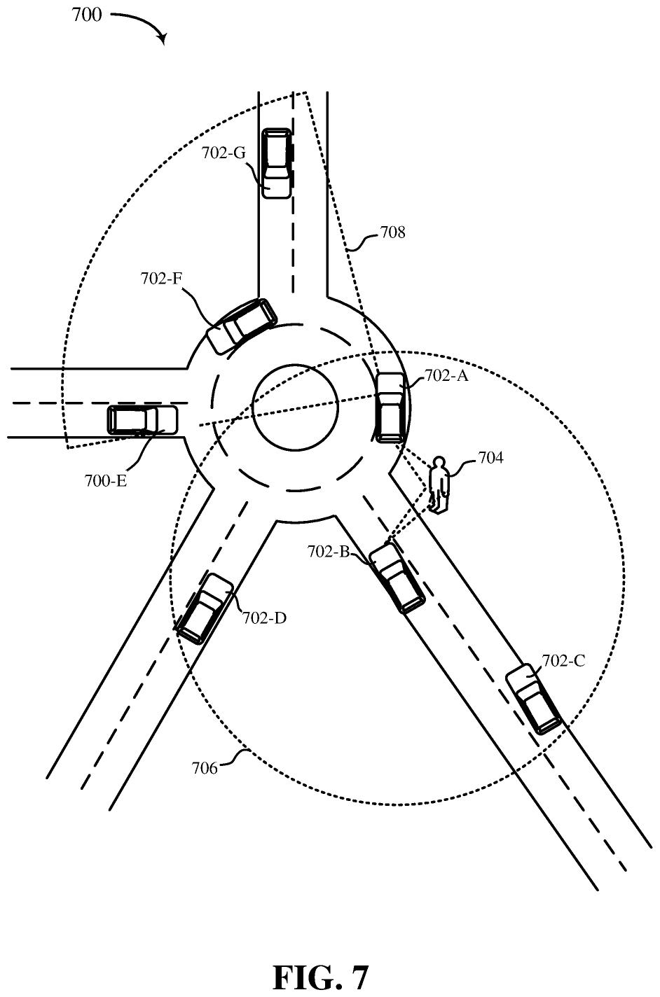

FIG. 7 is a schematic diagram illustrating a roadway 700 with a roundabout and a plurality of vehicles 702-A, 702-B, 702-C, 702-D, 702-E, 702-F, and 702-G. Each of the vehicles 702-A, 702-B, 702-C, 702-D, 702-E, 702-F, and 702-G may be an example of or include a UE 104/350 or other wireless communication device discussed herein. Each of the vehicles 702-A, 702-B, 702-C, 702-D, 702-E, 702-F, and 702-G may perform a distributed congestion algorithm, such as by performing the method discussed in relation to FIG. 5 or 8 for one or more detected objects.

In an example scenario, Vehicles 702-A and 702-B detect a pedestrian 704 near the roadway 700. Vehicle 702-B broadcasts a sensor-sharing message including information about the pedestrian 704 which is received by vehicles 702-A, 702-B, 702-C, and 702-D because they are within a coverage area 706 of the message transmitted by vehicle 702-B. Vehicle 702-A also detects the pedestrian 704 in addition to receiving the sensor-sharing message from vehicle 702-B. However, vehicle 702-A detection or classification quality (see 514 of method 500) is lower than the classification quality of vehicle 702-B. The vehicle 702-A may determine that the coverage area 706 of the message received from 702-B only covers part of a desired coverage area. For example, the coverage area 706 of the sensor-sharing message transmitted by vehicle 702-B does not completely cover the roundabout or other nearby roadways. Vehicle 702-A has a coverage area that could be used to notify devices not in vehicle 702-B's coverage area, such as vehicles 702-E, 702-F, and 702-G. Vehicle 702-A identifies that a desired or needed coverage area (such as the roadway within a threshold distance of the vehicle 702-A) is not covered in by coverage area 706 and would benefit from information about the pedestrian 704 and determines to share the information. The vehicle 702-A determines a direction and/or beam to provide a desired coverage area 708. Based on the beam or direction, the vehicle 702-A transmits a sensor-sharing message that includes information about the pedestrian 704 within the coverage area 708. Vehicles 702-E, 702-F, and 702-G receive the message transmitted by 702-A and thereby have information about the pedestrian 704 even if their sensors have not yet detected the pedestrian 704 directly.

FIG. 8 is a schematic swim lane diagram illustrating a method 800 for sensor sharing. The device 802-A may be on a roadway or in another driving environment where other devices 802-B, 802-C, and 802-E are also driving or are within a transmit or receive coverage area of the device 802-A. The devices 802-A, 802-B, 802-C, and 802-D may each be examples of a UE 104/350 or vehicle 402, 602, or 702, or other wireless communication device discussed herein. The method 800 may be performed by a device 802 which may include a UE 104, an OBU, vehicle 402, 602, or 702, or other wireless communication device. In one embodiment the method 800 may be performed by any other UE 104/350, vehicle, or wireless communication device discussed herein.

At 804, the device 802-A detects a first object. The first object may be an object that protrudes from or sits on a road or ground surface. The first object may be on or near a roadway or other location where vehicles are driven. The first object may be a static or stationary object such as a physical human-made structure, plant, physical barrier, road debris or other debris, or the like. The first object may be a dynamic or moving/movable object such as a motorized vehicle, human powered vehicle, a pedestrian, stroller, cart, animal, road debris or other debris, or the like. The device 802-A may detect the first object 802 using one or more sensors that are a part of or are in communication with the device 802-A. The one or more sensors may include one or more of a visible light camera, an infrared camera, a light detection and ranging (LIDAR) device, a radio detection and ranging (RADAR) device, an ultrasound detection device, or other sensor or device.

At 806, the devices 802-B and 802-C detect one or more second objects. The one or more second objects may include the first object. The devices 802-B and 802-C may detect the one or more second objects before, simultaneously with, or after the first device 802-A detects the first object. Similarly, one or both of devices 802-B and 802-C may detect the first object independently using their own one or more sensors.

At 808, the device 802-A determines one or more attributes of the first object. The attributes may include a physical attribute such as a dimension (a length, width, height of all or a portion of the object), a shape, a color, a structural or visual pattern of the object, or other physical attribute of the first object. The attributes may further include one or more of a distance from the device 802-A to the first object (or from the one or more sensors to the first object). The attributes may further include a relative motion and/or a relative direction of the first object with respect to the device 802-A or the one or more sensors. For example, the device 802-A may determine a direction and speed of travel (i.e., velocity) of the first object with respect to the device 802-A or a ground surface. The attributes may further include a classification or classification quality of the first object. The device 802-A may also determine a viewpoint of the first device with respect to the first object. The viewpoint may include a geographic direction (such as degrees relative to geographic north) or other direction. The device 802-A may determine the attributes based on information provided by the sensors. In one embodiment, one or more attributes may be determined directly by the one or more sensors, or another system, and provided to a processor or UE 104/350 of the device 802-A. Determining the one or more attributes at 808 may include determining the sensor types 508, distance to the object 510, and the device viewpoint of the object 512 of method 500. Detecting the object at 804 and determining one or more attributes at 808 of the first object may be one example of detecting an object at 502 of method 500.

At 810, the device 802-A determines a classification of the first object. The device 802-A may determine the classification based on the detection at 804 or the one or more attributes determined at 808. The device 802-A may determine the classification by classifying the first object as based on an output of the one or more sensors. The device 802-A may determine the classification by classifying the first object as one or more of a static object, a dynamic object, a hazardous object, or a non-hazardous object. The device 802-A may determine the classification by classifying the first object as one or more of a vehicle (such as a motorized vehicle), a vulnerable road user (pedestrian, cyclist, stroller), or debris. The classification may be based on a dimension, location, pattern in an image, radar signature, LIDAR pattern, or the like. In one embodiment, the classification may be based on the output of a neural network or other classification algorithm, device, or system. The device 802-A determining the classification at 810 may be an example of classifying 504 the object of method 500.

At 812, the device 802-A determines a classification quality for the classification of the first object. The device 802-A may determine the quality of the classification of the first object by determining based on a sensor type of the one or more sensors used to detect or classify the first object. For example, the classification quality may be based on whether the classification was done with image recognition of a camera image, based on a RADAR signature, or other sensor data. The device 802-A may determine the quality based on an accuracy of a sensor of the one or more sensors. The accuracy may correspond to the sensor type (camera vs RADAR) or to the specific model of sensor. For example, some camera models may have a higher accuracy than other camera model.

The device 802-A may determine the quality based on an aggregate sensor accuracy based on detection by two or more sensors of the one or more sensors. In some cases, classifications based on information from multiple sensors may have a higher accuracy and a higher quality classification because a larger amount and different types of information is used to determine the classification. The device 802-A may determine the quality based on a distance to the first object from the first device or the one or more sensors. Up to a point, shorter distances may lead to more information about the object, such as more pixels or more accurate determination of object attributes or classification. The device 802-A may determine the quality based on a viewpoint of the first device or the one or more sensors to the first object. For example, the viewpoint may be with respect to a geographical direction or a direction of travel of the object. Some objects may have higher object classifications from a side viewpoint (viewpoint perpendicular to the direction of travel) rather than a rear (viewpoint in same direction as the direction of travel) or front viewpoint (viewpoint in opposite direction from the direction of travel), by way of example. The device 802-A determining the classification quality at 812 may be an example of determining a quality of object classification 506 of method 500.

At 816, the device 802-A receives, and the devices 802-B and 802-C transmit, one or more messages indicating information about the one or more second objects. The messages at 816 may be transmitted and/or received at any time before, during, or after processes or procedures at 804, 808, 810, and/or 812. In one embodiment, the messages at 816 may be transmitted and/or received before the determining at 818 or 820.

The one or more messages received by the device 802-A (and transmitted by devices 802-B and 802-C transmit) at 816, may indicate detection of one or more second objects at the respective transmitting devices. The one or more messages may include information about the one or more second objects. The information about the one or more second objects may include one or more of a location, a classification, a classification quality, or an attribute of the one or more second objects. The location, classification, classification quality, or attribute may be determined by the transmitting devices 802-B and 802-C in a similar manner to that discussed at 804, 808, 810, and 812, above. Example attributes of the one or more second objects may include one or more of a distance from the one or more second object to the one or more second devices, a dimension of the one or more second objects, a relative direction of the one or more second object with respect to the one or more second devices, or a viewpoint of the one or more second devices with respect to the one or more second objects.

In one embodiment, the one or more messages indicate information about the one or more second devices. The information about the one or more second devices may include a location of the one or more second devices, such as a geographical location. Information about the one or more second devices may include a viewpoint of the one or more second devices with respect to the one or more second objects or a relative location of the one or more second devices with respect to the one or more second objects. The one or more messages from the one or more second devices may include a basic safety message that is transmitted periodically to indicate a location or other details of a respective transmitting device. The one or more messages from the one or more second devices may include a sensor-sharing message that indicates details about objects detected by a respective device. The one or more messages from the one or more second devices may include one or more of a D2D message, a sidelink message, a vehicle-to-vehicle (V2V) message, a vehicle to infrastructure (V2I) message, a V2X message, a broadcast message, a unicast message, or a group-cast message (e.g., a message to a platoon or other group).

At 818, the device 802-A determines whether the object detected at 804 (“first object”) corresponds to the one or more second objects indicated in the one or more messages at 816. In some cases, device 802-A may detect one or more of the same objects as other nearby devices. For example, one or more of devices 802-A, 802-B, 802-C, and 802-D may detect a same pedestrian, vehicle, structure, or other object. Multiple reports for the same object may utilize more wireless communication resources than needed and may cause congestion for wireless communications. The device 802-A may determine whether the first object corresponds to the at least one object of the one or more second objects based on one or more of an attribute, a classification, or a location of the first object matching an attribute, a classification, or a location of the at least one object of the one or more second objects. For example, if the information about one of the one or more second objects matches, or is similar enough to, the information about the first object, the device 802-A may determine that that object is the same object. The device 802-A determining whether the first object corresponds to at least one of the one or more second objects at 818 may be an example of determining whether a message was received about a same object at 520 of method 500.

At 820, the device 802-A determines a viewpoint of the devices 802-B and/or 802-C which sent the one or more messages about the one or more second objects at 816. For example, the device 802-A may determine the viewpoint of the corresponding device at the time a message at 816 was sent or a corresponding object was detected. The device 802-A may determine the viewpoint of the one or more second devices (e.g., devices 802-B and 802-C) based on a basic safety message received from the one or more second devices. For example, a basic safety message may include location information about the sending device. In one embodiment, the device 802-A may determine the viewpoint of the one or more second devices based on a sensor-sharing message received from the one or more second devices. For example, the sensor-sharing message may include information about a viewpoint, a location of the reporting device, and/or a location of the object. Thus, based on the information in the message the device 802-A may be able to determine the viewpoint of devices that transmitted messages at 816. Determining the viewpoint of other devices at 820 may be part of determining whether device 802-A's viewpoint is needed at 528 in method 500.

At 822, the device 802-A selects information, if any, about the first object to report. The device 802-A may select the information about the first object to report in the message to one or more third devices. The third devices may include one or more nearby devices such as devices device 802-B, device 802-C, and/or device 802-D. In one embodiment, the device 802-A may a may select the information about the first object to report based on whether the first object corresponds to the at least one object of the one or more second objects, determined at 818. For example, if the first object does not correspond to the one or more second objects, the device 802-A may determine to send the report. As another example, if the first object does not correspond to the one or more second objects, the device 802-A may determine to send the report unless the classification quality determined at 812 was below a threshold.

In one embodiment, the device 802-A may a may select the information about the first object to report based on the classification of the first object. For example, the parameters, attributes, or information to be reported may be different based on different classifications. In one embodiment, dynamic objects may be reported with information about a velocity, a heading, a vehicle/object type (such as pedestrian, bus, car, cyclist, etc.), time of detection, classification quality, or other information. In a related embodiment, static objects may not include velocity or heading information but may include an object type, time of detection, classification quality, or the like.

In one embodiment, the device 802-A selects the information about the first object to report based on in the information about the one or more second objects. For example, if one the one or more second objects correspond to the first object (see 818) the device 802-A may select information that is not redundant with information in the messages at 816. In some cases, the device 802-A may report some of the information it has about the first object but will withhold other information if it would not increase understanding about the object for nearby devices 802-B, 802-C, and/or 802-D. In one embodiment, the device 802-A selects the information about the first object to report based on whether a classification quality of the first object corresponding to the first device exceeds a classification quality of the first object from the one or more messages. The device 802-A may select the information to report based on whether a first coverage region of the one or more messages would be different than a second coverage region of the message to the one or more third devices (e.g., devices 802-B, 802-C, and 802-D). The device 802-A may select the information to report based on whether a viewpoint of the device 802-A is different than a viewpoint corresponding to the one or more messages (i.e., a viewpoint of devices 802-B and 802-C).

In one embodiment, selecting information, if any, about the first object to report at 822 may include the determinations and processes at 516, 518, 520, 522, 524, 526, and 528 of method 5. In some situations, the device 802-A may select no information about the first object to report. For example, the device 802-A may refrain from transmitting a sensor-sharing message or may transmit a sensor-sharing message that does not include any information about the first object detected at 804. In other situations, the device 802-A may select a subset of the information it has detected/determined about the first device to be reported. For example, the device 802-A may transmit a sensor-sharing message that includes information about the first object that is not redundant with information sent in other messages at 816. In yet other situations, the device 802-A may transmit a full set of information about the first object in a sensor-sharing message. The 802-A may select the information about the first object to report by excluding some or all information about the first object from a sensor-sharing message. The 802-A may select the information about the first object to report based on the information not being present in the one or more messages from the one or more second devices.

At 824, the device 802-A determines a transmit direction for transmitting any information about the first object. For example, if the device 802-A selects at least some information about the first object to report, the device 802-a may select a transmit direction. The transmit direction may include an omni-directional transmission or may include a beamformed or directional transmission. For example, given a desired coverage area the messages at 816 may cover all but a specific portion of the desired coverage area. The device 802-A may determine that it can cover the specific portion of the desired coverage area by transmitting using a directional beam and may use that beam for reporting information about the first object. In other cases, the device 802-A may determine that the specific portion of the desired coverage area that was not covered by the messages at 816 could not be covered by a directional transmission or would not be efficiently covered by a directional transmission. In this case, the device 802-A may determine an omni-directional transmission for transmitting the information about the first object. For example, the omni-directional or directional transmission may cover a region where the device 802-D is located. As another example, the omni-directional or directional transmission may cover a region where the devices 802-B, 802-C and 802-D are located. In one embodiment, the device 802-A may a determine the transmit direction as part of the broadcasting object information at 522 of method 500.

At 826, the device 802-A broadcasts information about the first object to one or more of the devices 802-B, 802-C and/or 802-D. In one embodiment, the device 802-A may broadcast the information about the first object as part of the broadcasting object information at 522 of method 500. The message about the first object may be transmitted by the device 802-A to one or more third devices, which may include the devices 802-B, 802-C that transmitted the messages at 816 and/or the device 802-D that did not transmit the messages at 816. The device 802-A may broadcast the information in a basic safety message, a sensor-sharing message, or other message. The broadcast by the device 802-A may include one or more of a device-to-device message, a sidelink message, a vehicle-to-vehicle message, a vehicle to infrastructure message, a vehicle-to-anything message, a broadcast message, or a group-cast message. In one embodiment, the device may send the message as part of a unicast message instead of or in addition to broadcasting the information about the first device.

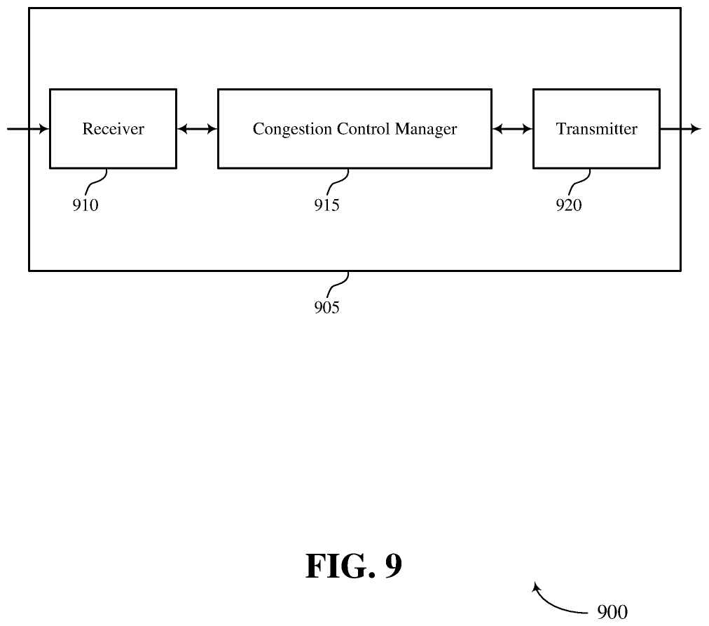

FIG. 9 shows a block diagram 900 of a device 905 supporting beam grouping for inter-band carrier aggregation in accordance with aspects of the present disclosure. The device 905 may be an example of aspects of a device such as a UE 104/350 device 402/602/702/802 or any other wireless communication device described or discussed herein. The device 905 may include a receiver 910, a congestion control manager 915, and a transmitter 920. The device 905 may also include a processor. Each of these components may be in communication with one another (e.g., via one or more buses).

The receiver 910 may receive information such as packets, user data, reference signals, sensor-sharing messages, basic safety message, or control information associated with various information channels (e.g., control channels, data channels, or other channels). The information may be received on one or more links or one or more beams. Information may be passed on to other components of the device 905. The receiver 910 may utilize a single antenna or a set of antennas. The receiver 910 may receive message such as those discussed at 520, 522, 816, and/or 826.

The congestion control manager 915 performs functions to limit information about objects reported in sensor-sharing messages or other messages. For example, the congestion control manager 915 may operate on each UE or other device to provide a distributed congestion control to limit the amount of wireless communication resources used to share information about detected objects with nearby wireless communication devices. The congestion control manager 915 may perform any of the functions, processes, or methods discussed in FIGS. 4A, 4B, 5, 6, 7, and 8. For example, the congestion control manager 915 may perform the functions of the UE 104 of FIG. 1, of the vehicles 402-A, 402-B, 402-C, 402-D, 402-E, 402-F, and 402-G of FIGS. 4A and 4B, of the method 500 of FIG. 5, of the vehicles 602-A, 602-B, and 602-C of FIG. 6, of the vehicles 702-A, 702-B, 702-C, 702-D, 702-E, 702-F, and 702-G of FIG. 7, or of the devices 802-A, 802-B, 802-C, and 802-D of FIG. 8 such as those at 804, 806, 808, 810, 812, 816, 818, 820, 822, 824, and 826, or any combination thereof.

The congestion control manager 915, or its sub-components, may be implemented in hardware, code (e.g., software or firmware) executed by a processor, or any combination thereof. If implemented in code executed by a processor, the functions of the congestion control manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure. The congestion control manager 915 may include the memory 360, code stored in the memory 360, and/or the controller/processor 359 of UE 350.

The congestion control manager 915, or its sub-components, may be physically located at various positions, including being distributed such that portions of functions are implemented at different physical locations by one or more physical components. In some examples, the congestion control manager 915, or its sub-components, may be a separate and distinct component in accordance with various aspects of the present disclosure. In some examples, the congestion control manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. For example, the transmitter 902 may transmit reference signals, data messages, or control messages. In some examples, the transmitter 920 may be collocated with a receiver 910 in a transceiver module. For example, the transmitter 920 may be an example of aspects of the transmitter/receiver 354 of FIG. 3. The transmitter 920 may utilize a single antenna or a set of antennas. The transmitter 920 may transmit messages such as those discussed at 520, 522, 816, and/or 826.

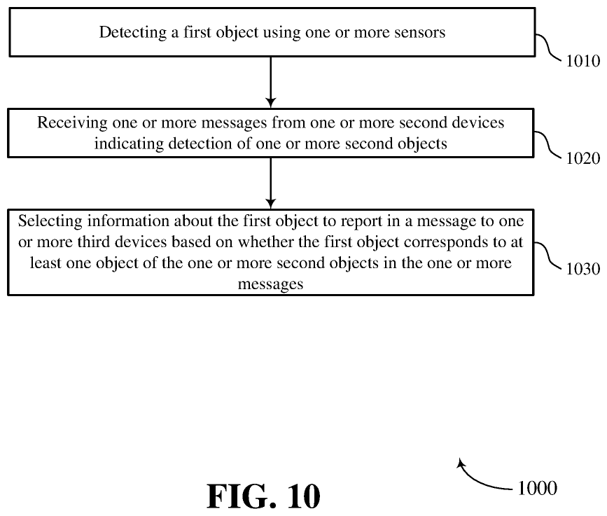

FIG. 10 is a flowchart of a method 1000 for distributed congestion control for sensor sharing, in accordance with certain aspects of the disclosure. This method 1000 may be performed by any wireless communication device described or discussed herein, such as a UE 104/350 device 402/602/702/802/905 or any other wireless communication device described or discussed herein.

In the method 1000, the device detects 1010 a first object using one or more sensors. The detecting 1010 may include, for example, one or more of the aspects discussed in relation to 502 of FIG. 5 or 804 of FIG. 8. The device receives 1020 one or more messages from one or more second devices indicating detection of one or more second objects. The one or more messages may indicate information about the one or more second objects. The receiving 1020 may include, for example, one or more of the aspects discussed in relation to 816 of FIG. 8. The device selects 1030 information about the first object to report in a message to one or more third devices based on whether the first object corresponds to at least one object of the one or more second objects in the one or more messages. The selecting 1030 may include, for example, one or more of the aspects discussed in relation to 504, 506, 516, 520, 524, 526, and 528, of FIG. 5 and 822 of FIG. 8. Furthermore, the method 1000 may include additional operations, steps, or procedures such as one or more aspects discussed at 518 and 522 of FIGS. 5 and 808, 810, 812, 818, 820, 824, and 826 of FIG. 8.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1-34. (canceled)

35. A method comprising:
detecting, by a first device, a first object using one or more sensors;
receiving, by the first device, one or more messages from one or more second devices indicating detection of one or more second objects, the one or more messages indicating information about the one or more second objects; and
selecting information about the first object to report in a message to one or more third devices based on whether the first object corresponds to at least one object of the one or more second objects in the one or more messages.

36. The method of claim 35, further comprising determining one or more attributes of the first object.

37. The method of claim 36, wherein the one or more attributes of the first object comprises one or more of:
a distance from the first object to the first device or the one or more sensors;
a dimension of the first object;
a relative direction of the first object with respect to the first device or the one or more sensors; or
a viewpoint of the first device with respect to the first object.

38. The method of claim 35, wherein the information about the one or more second objects comprise one or more of:
a location;
a classification;
a classification quality;
a distance from the one or more second object to the one or more second devices;
a dimension of the one or more second objects;
a relative direction of the one or more second object with respect to the one or more second devices; or
a viewpoint of the one or more second devices with respect to the one or more second objects.

39. The method of claim 35, wherein selecting the information about the first object to report in the message to the one or more third devices further comprises selecting based on the information about the one or more second objects.

40. The method of claim 35, wherein the one or more messages indicate information about the one or more second devices, wherein the information about the one or more second devices comprises one or more of:
a location of the one or more second devices;
a viewpoint of the one or more second devices with respect to the one or more second objects; or
a relative location of the one or more second devices with respect to the one or more second objects.

41. The method of claim 35, wherein the one or more messages from the one or more second devices comprise a basic safety message.

42. The method of claim 35, wherein the selecting the information about the first object to report comprises one of:
excluding some or all information about the first object; or
selecting information about the first object based on the information not being present in the one or more messages from the one or more second devices.

43. The method of claim 35, further comprising transmitting the message to the one or more third devices.

44. The method of claim 35, further comprising determining a direction of transmission for the message to the one or more third devices, wherein transmitting the message to the one or more third devices comprises transmitting in the direction of transmission.

45. The method of claim 35, further comprising determining whether the first object corresponds to the at least one object of the one or more second objects, wherein the selecting information about the first object to report comprises selecting based on the determining whether the first object corresponds to the at least one object of the one or more second objects.

46. The method of claim 35, further comprising determining a quality of a classification of the first object, based on one or more of:
a sensor type of the one or more sensors used to detect or classify the first object;
an accuracy of a sensor of the one or more sensors;
an aggregate sensor accuracy based on detection by two or more sensors of the one or more sensors;
a distance to the first object from the first device or the one or more sensors; or
a viewpoint of the first device or the one or more sensors to the first object.

47. An apparatus comprising:
one or more processors;
memory in electronic communication with the one or more processors, the memory storing instructions which, when executed by the one or more processors, cause the apparatus to:
detect, by a first device, a first object using one or more sensors;
receive, by the first device, one or more messages from one or more second devices indicating detection of one or more second objects, the one or more messages indicating information about the one or more second objects; and
select information about the first object to report in a message to one or more third devices based on whether the first object corresponds to at least one object of the one or more second objects in the one or more messages.

48. The apparatus of claim 47, wherein the instructions which, when executed by the one or more processors, further cause the apparatus to determine one or more attributes of the first object.

49. The apparatus of claim 48, wherein the one or more attributes of the first object comprises one or more of:
a distance from the first object to the first device or the one or more sensors;
a dimension of the first object;
a relative direction of the first object with respect to the first device or the one or more sensors; or
a viewpoint of the first device with respect to the first object.

50. The apparatus of claim 47, wherein the information about the one or more second objects comprise one or more of:
a location;
a classification;
a classification quality;
a distance from the one or more second object to the one or more second devices;
a dimension of the one or more second objects;
a relative direction of the one or more second object with respect to the one or more second devices; or
a viewpoint of the one or more second devices with respect to the one or more second objects.

51. The apparatus of claim 47, wherein the instructions which, when executed by the one or more processors, further cause the apparatus to select the information about the first object to report in the message to the one or more third devices further comprises selecting based on the information about the one or more second objects.

52. The apparatus of claim 47, wherein the one or more messages indicate information about the one or more second devices, wherein the information about the one or more second devices comprises one or more of:
a location of the one or more second devices;
a viewpoint of the one or more second devices with respect to the one or more second objects; or
a relative location of the one or more second devices with respect to the one or more second objects.

53. The apparatus of claim 47, wherein the one or more messages from the one or more second devices comprise a basic safety message.

54. The apparatus of claim 47, wherein the instructions which, when executed by the one or more processors, cause the apparatus to select the information about the first object to report by one or more of:
excluding some or all information about the first object; or
selecting information about the first object based on the information not being present in the one or more messages from the one or more second devices.

55. The apparatus of claim 47, wherein the instructions which, when executed by the one or more processors, further cause the apparatus to transmit the message to the one or more third devices.

56. The apparatus of claim 47, wherein the instructions which, when executed by the one or more processors, further cause the apparatus to determine a direction of transmission for the message to the one or more third devices, wherein the transmitting the message to the one or more third devices comprises transmitting in the direction of transmission.

57. The apparatus of claim 47, wherein the instructions which, when executed by the one or more processors, further cause the apparatus to determine whether the first object corresponds to the at least one object of the one or more second objects, wherein the selecting information about the first object to report comprises selecting based on the determining whether the first object corresponds to the at least one object of the one or more second objects.

58. The apparatus of claim 47, wherein the instructions which, when executed by the one or more processors, further cause the apparatus to determine a quality of a classification of the first object, based on one or more of:
a sensor type of the one or more sensors used to detect or classify the first object;
an accuracy of a sensor of the one or more sensors;
an aggregate sensor accuracy based on detection by two or more sensors of the one or more sensors;
a distance to the first object from the first device or the one or more sensors; or
a viewpoint of the first device or the one or more sensors to the first object.

59. A non-transitory computer readable memory storing instructions which, when executed by one or more processors, cause the processors to:
detect, by a first device, a first object using one or more sensors;
receive, by the first device, one or more messages from one or more second devices indicating detection of one or more second objects, the one or more messages indicating information about the one or more second objects; and
select information about the first object to report in a message to one or more third devices based on whether the first object corresponds to at least one object of the one or more second objects in the one or more messages.

60. The computer readable memory of claim 59, wherein the instructions which, when executed by the one or more processors, further cause the processors to determine one or more attributes of the first object.

61. The computer readable memory of claim 60, wherein the one or more attributes of the first object comprises one or more of:
a distance from the first object to the first device or the one or more sensors;
a dimension of the first object;
a relative direction of the first object with respect to the first device or the one or more sensors; or
a viewpoint of the first device with respect to the first object.

62. The computer readable memory of claim 59, wherein the information about the one or more second objects comprise one or more of:
a location;
a classification;
a classification quality;
a distance from the one or more second object to the one or more second devices;
a dimension of the one or more second objects;
a relative direction of the one or more second object with respect to the one or more second devices; or
a viewpoint of the one or more second devices with respect to the one or more second objects.

63. The computer readable memory of claim 59, wherein the instructions which, when executed by the one or more processors, further cause the processors to select the information about the first object to report in the message to the one or more third devices further comprises selecting based on the information about the one or more second objects.

64. An apparatus comprising:
means for detecting, by a first device, a first object using one or more sensors;
means for receiving, by the first device, one or more messages from one or more second devices indicating detection of one or more second objects, the one or more messages indicating information about the one or more second objects; and
means for selecting information about the first object to report in a message to one or more third devices based on whether the first object corresponds to at least one object of the one or more second objects in the one or more messages.
